(19) United States
(12) Patent Application Publication
(10) Pub. No.: US 2003/0006321 A1
(43) Pub. Date: Jan. 9, 2003

(54) Tubular voltage multiplier powder gun

(76) Inventor: Brian D. Mather, North Olmsted, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/188,715

(22) Filed: Jul. 2, 2002

Related U.S. Application Data
(60) Provisional application No. 60/303,602, filed on Jul. 6, 2001.

(51) Int. Cl. B05B 5/00

(52) U.S. Cl. 239/690; 239/706; 239/707; 239/698

(57) ABSTRACT

A power supply for an electrostatic powder spray gun is formed in the shape of a hollow cylinder with a central passageway therethrough. A powder tube is slideably inserted through the central passageway of the power supply thus providing a more compact and symmetric spray gun profile. The power supply may be a voltage multiplier, for example.

### RELATED APPLICATION

This application claims the benefit of pending U.S. Provisional patent application serial No. 60/303,602 filed on Jul. 6, 2001 for TUBULAR VOLTAGE MULTIPLIER POWDER GUN, the entire disclosure of which is fully incorporated herein by reference.

### TECHNICAL FIELD OF THE INVENTION

The present invention relates to powder spray guns used in electrostatic spray systems. More particularly, the invention relates to methods and apparatus for providing electrical energy and powder to an electrostatic spray gun using a power supply that at least partially surrounds a powder feed tube.

### BACKGROUND OF THE INVENTION

In a typical electrostatic powder spraying process, powder coating material is conveyed in an air stream to a powder spray gun which electrostatically charges the powder coating material to a high voltage potential. The charging system of the spray gun generally operates at a potential of at least 60 kilovolts (kV). Usually, the powder spray gun sprays powder coating material on electrically conductive, or at least partially conductive objects. To attract the powder coating material to the object, the powder particles are charged to a different polarity than the object. The objects are usually held at ground voltage potential in an appropriate manner. Electrostatic forces between the charged powder particles and the grounded conductive object cause the powder particles to be drawn to and adhere to the object. Charging is usually accomplished in the spray gun by an electrode connected to an internal high voltage power supply, such as a voltage multiplier. The electrode is placed in close proximity to or even in contact with the stream of powder.

Prior electrostatic powder spray guns have at least two different design configurations. In one spray gun configuration, a gun housing encloses a voltage multiplier and an electrode which are aligned along a longitudinal axis. The gun housing also includes a powder inlet and a powder outlet communicating by a powder passageway. The center of the powder outlet aligns with the longitudinal axis, but the center of the powder inlet is not aligned with the same axis. Therefore, the powder passageway traverses a nonlinear path between the powder inlet and the powder outlet. At a downstream location from the powder inlet and typically the voltage multiplier, the powder passageway intersects and thereafter encircles the electrode. Between this intersection point and powder outlet, the powder passageway substantially coincides with the longitudinal axis. An example of such a spray gun can be found in U.S. Pat. No. 5,341,989, assigned to the assignee of the present invention, the entire disclosure of which is fully incorporated herein by reference.

In another spray gun configuration, a gun housing encloses a voltage multiplier and an electrode. Unlike the spray gun described above, however, the voltage multiplier and the electrode are not aligned along a common longitudinal axis. The gun housing also includes powder inlet and a powder outlet communicating by way of a powder passageway. In this design, the powder passageway transverses a substantially linear path along a longitudinal axis between the powder inlet and powder outlet. In contrast, the multiplier is axially offset from the axis of the powder flow path. At a downstream location from the discharge end of the voltage multiplier, the electrode intersects and thereafter is encircled by the power passageway. After intersecting the powder passageway, the electrode may traverse up the center of the powder passageway and terminate proximate the powder outlet.

Ideally, an electrostatic powder spray gun needs a purge cleanable powder passageway and a robust electrical path between the voltage multiplier and the electrode. A purge cleanable powder passageway can be effectively cleared of residual or accumulated powder by a burst or bursts of purge air. Furthermore, a purge cleanable powder passageway minimizes or eliminates undesirable accumulation of powder in the powder passageway during the spraying operation. A robust electrical path restricts the high voltage and current developed by the voltage multiplier to a highly efficient conductive path. Specifically, the robust electrical path prevents significant current leakage, especially at the interface of the voltage multiplier and the electrode.

In the first configuration, the powder passageway can be difficult to purge clean. Because the entire powder passageway intersects the electrode at an angle relative to the longitudinal axis of the electrode, powder tends to collect or accumulate at this intersection, as the powder passageway curves to intersect and thereafter encircle the electrode. The geometry of the powder passageway at the intersection with the electrode can hamper removal of accumulated powder using purge air. Leaving the accumulated powder within the powder passageway degrades the performance of the spray gun.

The second configuration, however, does have a powder passageway which is purge cleanable. Because the powder passageway is essentially a straight path, it can be effectively cleared of accumulated powder with a burst or burst of purge air. However, the offset voltage multiplier increases the size of the spray gun and provides a non-uniform geometry. The non-uniform geometry arises from the fact that the multiplier tends to be a rather large component within the gun housing so that having to offset the alignment of the multiplier relative to the powder flow path necessarily increases the diameter or width of the gun, making the gun profile bulkier and somewhat more clumsy to handle.

### SUMMARY OF THE INVENTION

In accordance with one aspect of the invention, a power supply for an electrostatic powder spray gun is contemplated that permits a more compact and symmetrical gun configuration. In one embodiment, the power supply is formed with a central passageway that slideably receives a powder tube of the spray gun. By having the power supply at least partially surround the powder tube, a shorter gun can be realized within a smaller envelope. The symmetrical tube configuration will also tend to collect less powder overspray, be easier to clean and also easier to handle for manual gun configurations and tube mount configurations. The power supply in one embodiment is coaxial with the powder tube thereby allowing the powder tube to extend lengthwise in a straight line along a single axis from an inlet end to an outlet end of the powder tube. In accordance with another aspect of the invention, a power supply is provided in a generally cylindrical configuration, with an outer surface that may form part of the spray gun housing. In a more particular embodiment, the power supply comprises a high voltage multiplier that produces at least 60 kV of power.

These and other aspects and advantages of the present invention will be apparent to those skilled in the art from the following description of the preferred embodiments in view of the accompanying drawings.

### BRIEF DESCRIPTION OF THE DRAWINGS

The invention may take physical form in certain parts and arrangements of parts, preferred embodiments and a method of which will be described in detail in this specification and illustrated in the accompanying drawing which forms a part hereof, and wherein:

FIGS. 1A and 1B illustrate a spray gun in one embodiment of the invention, shown in longitudinal cross-section;

FIG. 2 is another embodiment of an electrical connection between a power supply in accordance with the invention and one or more electrodes;

FIGS. 3 and 4 illustrate another embodiment of the invention; and

FIG. 5 illustrates a powder hose connector configuration.

### DETAILED DESCRIPTION OF THE PREFERRED EMBODIMENTS

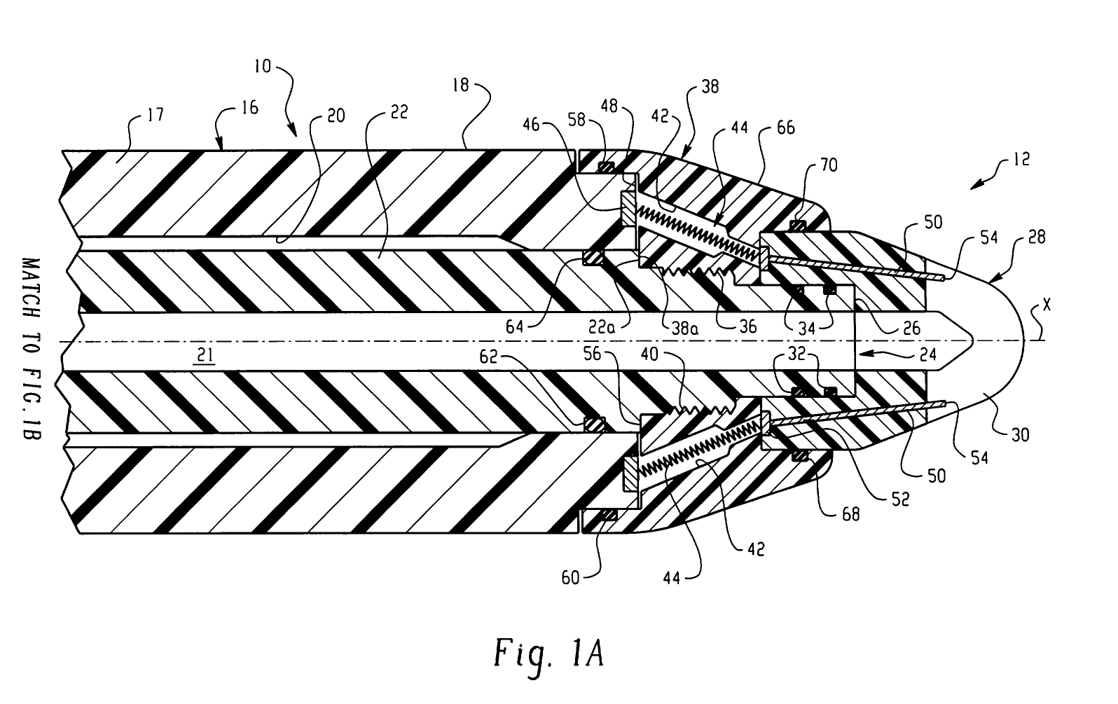

With reference to FIGS. 1A and 1B, the present invention contemplates an internal power supply for an electrostatic powder spray gun that is integrated into the gun design so as to result in a more compact and easier to use apparatus. While the invention is described herein with reference to a specific embodiment and alternative embodiments, such descriptions are intended to be exemplary in nature and should not be construed in a limiting sense. Those skilled in the art will readily appreciate that the present invention may be realized in a wide variety of electrostatic powder spray gun designs. Furthermore, while various aspects of the invention are described herein and may be illustrated as being incorporated together into a single embodiment, such descriptions are not intended to be limiting. The various aspects of the invention may be used in combination as described herein or individually or various combinations and sub-combinations thereof.

In accordance with one aspect of the invention, a power supply is provided that permits a powder tube to be slideably inserted therethrough such that the power supply closely surrounds at least a portion of the powder tube. This configuration allows for a shorter and more compact gun. In accordance with another aspect of the invention, the power supply may be generally annular, thereby providing a symmetric gun profile that is easier to clean and handle.

In the embodiment of FIGS. 1A and 1B, an electrostatic powder spray gun 10 includes a forward powder outlet or nozzle end 12 (FIG. 1A) and a powder inlet end 14 (FIG. 1B). The spray gun 10 includes a power supply 16 that is formed as a hollow cylinder. The power supply 16 preferably although not necessarily includes an outer surface 18 that forms part of the outer structure or housing of the spray gun 10. Alternatively, the power supply 16 may be disposed within a separate outer housing or shell (not shown).

The power supply 16 is preferably in the form of a hollow cylinder body 17 having a central passageway 20 therethrough (note that in all the drawings various gaps and spaces are exaggerated for clarity and ease of illustration). The power supply 16 defines a central longitudinal axis X of the spray gun 10. The passageway 20 is appropriately dimensioned to slideably receive a powder tube 22 therein. Preferably although not necessarily the powder tube 22 is closely received within the power supply 16 so as to be supported by the power supply 16. The powder tube 22 extends coaxially through the power supply 16. Note that in the drawings the power supply body 17 is illustrated without showing the details of the electrical circuit components contained therein. The power supply circuitry may be conventional in design as is well known to those skilled in the art. The circuit components may be housed within the body 17 or embedded therein such as with a suitable potting material for example.

It is important to note that although the preferred geometry of the power supply 16 is generally cylindrical, such a shape is not required to realize the benefits of the present invention. Any geometric shape may be used that permits the powder tube to extend therethrough generally coaxially, such as for example and not by way of limitation, a polygon such as a hexagon, nonagon, ellipse and so on. The power supply 16 also need not be symmetrical although such is the preferred configuration. The power supply 16 also need not be circumferentially continuous, especially in cases where the power supply is received within an outer shell or housing. The power supply in such cases, for example, may only partially surround the powder tube 22, such as, for example, a hemispherical form. The power supply may also extend only part way axially along the powder tube, with the housing or shell providing a complete enclosure for the spray gun 10.

A forward powder outlet end 24 of the powder tube 22 is adapted to be slideably inserted into a counterbore 26 formed in a nozzle 28. This allows the nozzle 28 to be slip fitted onto the powder tube 22 and to be in communication therewith such that powder is sprayed out one or more orifices or slots 30 formed in the nozzle 28. The forward end 24 of the powder tube may include one or more grooves 32 that retain suitable seals 34 such as o-rings, for example. The seals 34 provide a frictional fit for the nozzle 28 on the powder tube 22 and also seal against loss of powder during a spraying operation.

The powder tube 22 preferably extends in a straight line fashion along the axis X from its inlet end 23 (FIG. 1B) to its outlet end 24. By using a powder tube 22 that has no bends or turns in the powder flow path and only a single interface to the nozzle 28, purging and cleaning of the powder path is greatly simplified for color change operations or other cleaning requirements. The nozzle 28 and powder tube 22 can even be simply swapped out with minimal effort to provide an alternative quick color change procedure.

The powder tube 22 includes a male threaded portion 36 that is axially spaced from the forward end 24 of the powder tube. A first clamping nut 38 includes corresponding mating female threads 40 so that the clamping nut is threadably installed onto the powder tube 22. A threaded connection between the clamping nut 38 and the powder tube 22, however, is only one of many methods available to connect the parts together. Other options include but are not limited to a snap fit, a retaining ring and so on, as will be readily apparent to those skilled in the art. The first clamping nut 38 includes an inward shoulder 38a that abuts against a corresponding shoulder 22a formed in the outer surface of the powder tube 22 when the two parts are fully assembled. The clamping nut 38 includes one or more bores 42 that retain a respective spring contact 44. Each spring contact 44 extends through its respective bore 42 and at a back end makes electrical contact with an electrical output contact 46 of the power supply 16. The output contact 46 provides a high voltage output from the power supply for electrostatically charging powder sprayed by the gun 10. In the illustrated embodiment of FIG. 1A, the output contact 46 is realized in the shape of a circumferential ring provided in a forward face 48 of the power supply body 17. This ring is wired internally to a high voltage output line of the power supply 16. The contact springs 44 are somewhat compressed upon complete assembly of the gun 10 so as to make good electrical contact with the output contact ring 46. Those skilled in the art will readily appreciate that there are many alternative ways to establish electrical contact with the output of the power supply 16, including spring biased push pins and so on, all of which options would function suitably with the present invention.

Each contact spring 44 at an end opposite the power supply 16 also is electrically coupled or connected to a respective electrode 50. Each electrode extends through the nozzle 28 from a nozzle contact ring 52 to a free end 54 that preferably is positioned within the powder flow path for powder being ejected from the nozzle 28. For example, as shown the electrodes 50 extend partially into a slot 30 of the nozzle 28. Other locations for the electrodes may be chosen as required for a particular nozzle and gun design.

The clamping nut 38 includes a recess 56 that slideably receives a forward end of the power supply 16. A seal groove 58 and seal 60 may be provided as required. The powder tube 22 may also include an outer circumferential seal groove 62 and seal 64 for protecting against loss of powder and to hold the gun together with a good frictional fits between the various components. The clamping nut 38 may serve as a fairing with an appropriately tapered outer surface 66 to provide a smooth outer surface transition between the power supply 16 and the nozzle 28. An additional seal groove 68 and seal 70 may be provided to secure the nozzle 28 snugly into the clamping nut 38 and to provide a powder seal. Alternatively the nozzle 28 may be threadably installed in the forward end of the clamping nut 38.

The back end or powder inlet end 23 of the powder tube 22 is provided with a conventional tapered hose connector 72 with a detent 74 to help hold the hose on the connector (hose not shown in the drawing). The inlet end 23 further includes a male threaded portion 78 that threadably mates with a second clamping nut 80. When threaded onto the powder tube 22 end, the clamping nut axially compresses an end cap 82 up against a back end 84 of the power supply 16, thereby axially securing the power supply between the first clamping nut 38 and the second clamping nut 80 to hold the gun 10 rigidly together. A suitable bar mount 86 may be provided on the end cap 82 for bar mount configurations. Alternatively, for tube mount configurations a suitable bracket (not shown) would be used to mount the gun 10 to a gun support or gun mover.

An electrical cable 88 is provided to connect a low voltage input from a source 90 to an input of the power supply 16. The power supply then steps up this low input voltage to a suitable high voltage output at the output contact ring 46. The power supply 16, for example, may be any voltage multiplier well known to those skilled in the art, for example.

One form of assembly is as follows. The first clamping nut 38 is threaded onto the threaded portion 36 of the powder tube 22. Next, the nozzle 28 may be slip fitted onto the outlet end 24 of the powder tube. The power supply 16 forward end 48 is then slipped into the back end of the first clamping nut 38, the end cap 82 is installed and then the second clamping nut 80 is installed onto the threaded back end of the powder tube 22 and tightened to fully clamp the assembly together. The electrical cable 88 may then be attached to the power supply 16 when a spraying operation is to begin. Color change cleaning can be easily effected by providing pressurized purge air through the powder tube 22 and nozzle 28, or alternatively those parts can be easily interchanged with different ones.

An additional seal groove 92 and seal 94 may be provided near the back end of the powder tube 22 to provide a seal and snug fit of the powder tube 22 within the central passageway 20 of the power supply 16.

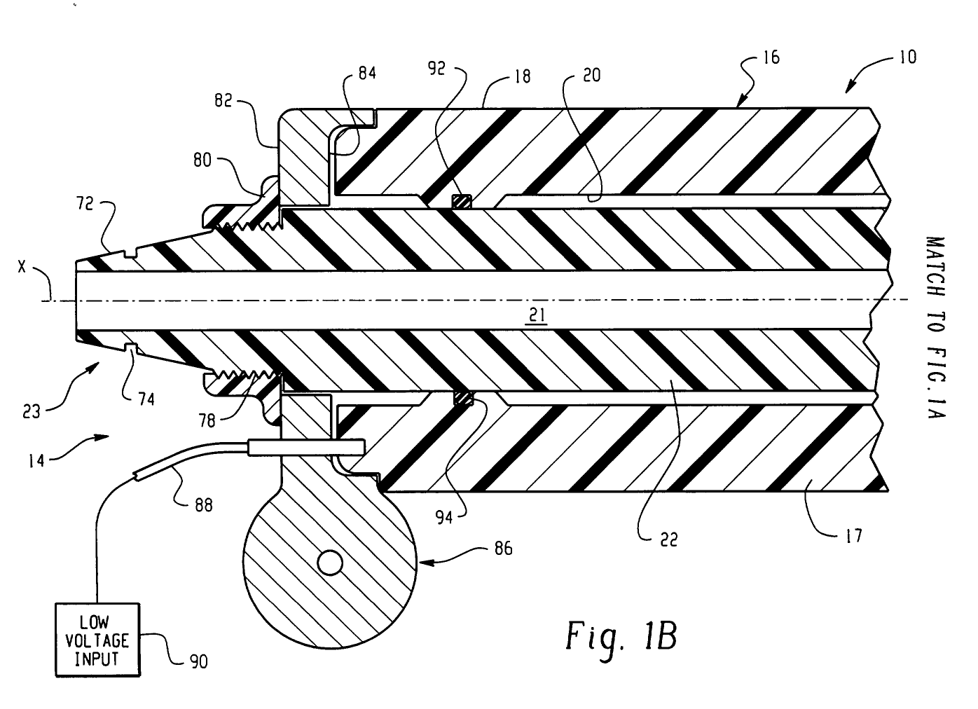

FIG. 2 illustrates an alternative configuration for electrostatically charging powder traveling through the powder tube 22. In this embodiment, the nozzle 28 may be the same design as described herein before with respect to FIGS. 1A and 1B, except that the electrodes 50 are omitted from the nozzle 28. In this embodiment, the first clamping nut 38 is modified to include one or more a radial bores 100 that retain a respective spring contact 102. A circumferential powder tube contact ring 104 is provided in a circumferential recess 106 formed in powder tube 22. One or more electrodes 108 are connected to or integral with the powder tube contact ring 104 and extend into the interior powder flow path 21 of the powder tube. In this manner, the powder is charged as it flows through the powder tube 22 rather than at the nozzle 28. Alternatively of course powder may be charged at both locations. The recess 106 is positioned at a suitable location so as to effectively apply an electrostatic charge to the powder as it flows through the powder tube 22.

Each contact spring 102 electrically contacts at one end the powder tube contact ring 104 and at an opposite end contacts a conductor 110 that extends through the first clamping nut 38 to the clamping nut contact ring 46. The powder tube 22 includes the male threaded portion 36 that cooperates with female threaded portion 40 of the clamping nut 38 as previously described herein. The back end of the spray gun may be substantially as described herein before, and the gun may be assembled in a similar manner.

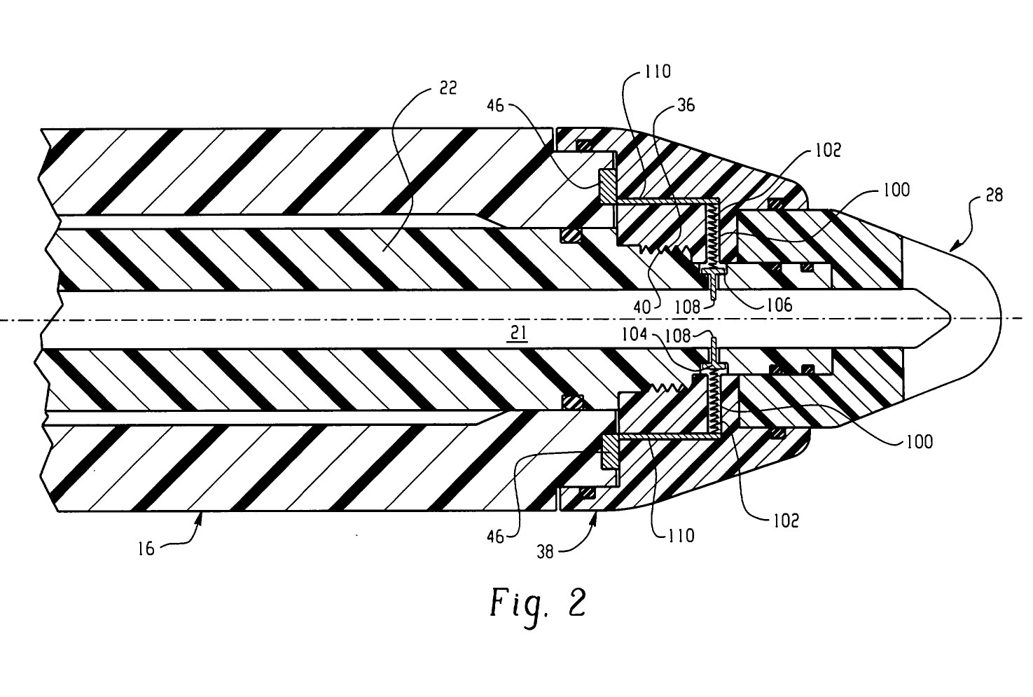

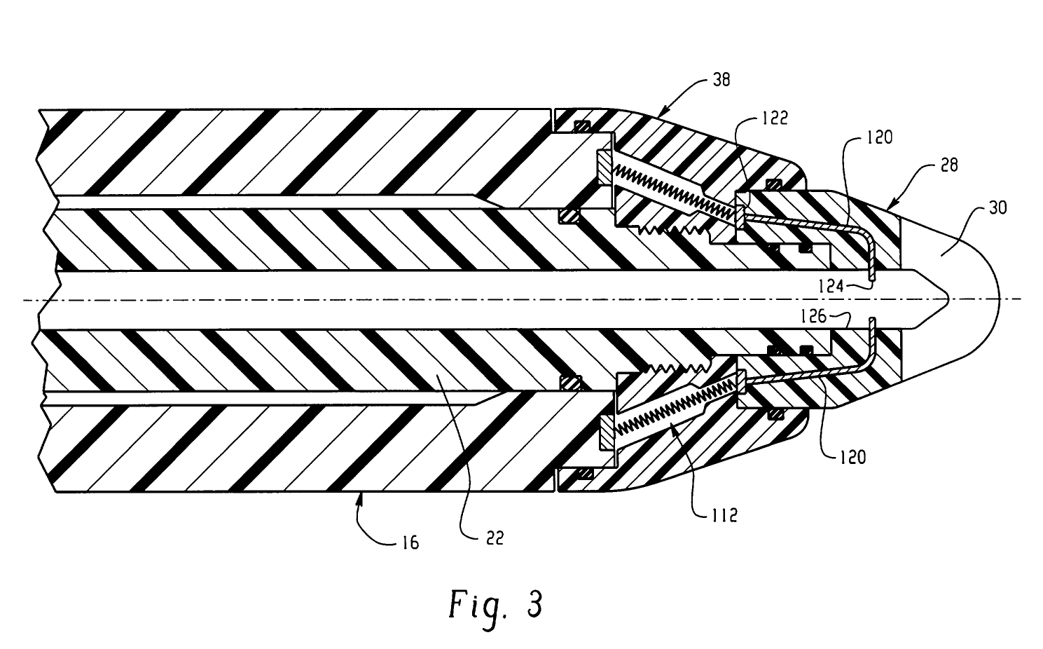

With reference to FIGS. 3 and 4 (FIG. 4 being an enlarged view of the nozzle used in FIG. 3), the electrode connection is again illustrated in an alternative form. In this example, an electrical path 112 is provided through the first clamping nut 38 as described herein before to make electrical contact with the output of the power supply 16 and the electrodes as previously described herein before, such as, for example, with contact springs. However, the nozzle 28 is modified to be in the form of a molded part, such as made from PTFE or any other suitable material. The electrodes 120 and a nozzle contact ring 122 may be embedded into the nozzle 28 as part of the molding operation. The electrode tips 124 may be exposed to the powder flowing through the nozzle 28 at any suitable location, such as in the central passageway 126 as illustrated in FIG. 4 or in the slots 30 as illustrated in FIG. 1A.

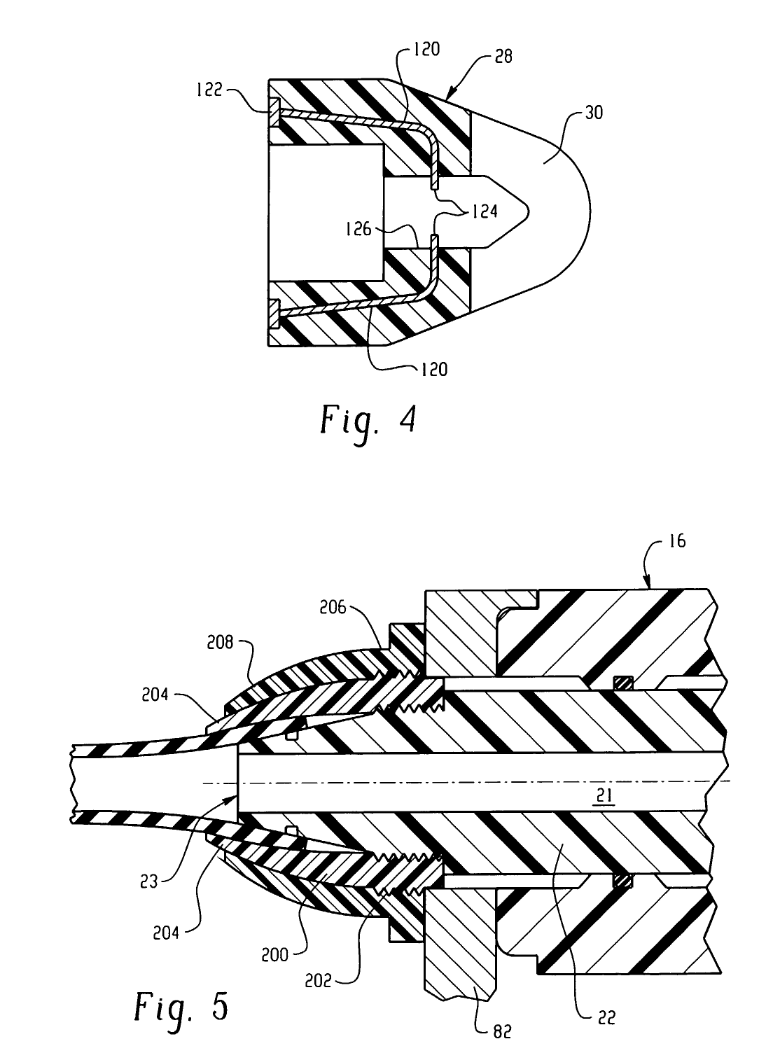

With reference again to FIG. 5, the second clamping nut 80 may be replaced with a hose clamp ring 200 that has a male threaded portion 202. The clamp ring 200 includes flexible fingers 204 that extend generally axially from the threaded portion 202 over the end of a hose attached to the powder tube inlet end 23. These fingers are compressed down onto the hose by a clamping nut 206 that is threaded onto the clamping ring 200. The clamping nut 206 includes a generally axially extending body or skirt 208 that is tapered to a somewhat smaller diameter than the flexible fingers 204 such that as the clamping nut 206 is tightened onto the clamp ring 200, the skirt 208 radially compresses the flexible fingers 204 into a firm gripping action on the coupled hose. The clamping nut 206 axially compresses the gun assembly together in a manner similar to the second clamping nut 80 in the other embodiments herein. The elongated nut 206 also, however, compresses the flexible fingers 204 against the hose to make a more secure hose connection.

The invention has been described with reference to the preferred embodiment. Modifications and alterations will occur to others upon a reading and understanding of this specification. It is intended to include all such modifications and alterations insofar as they come within the scope of the appended claims or the equivalents thereof.

1. In an electrostatic powder spray gun, the improvement comprising:
a powder tube having a powder inlet end and a powder outlet end; and
a power supply that at least partially surrounds a portion of said powder tube.

2. The spray gun of claim 1 wherein said powder tube extends along a single straight axis from its inlet end to its outlet end.

3. The spray gun of claim 2 wherein said power supply extends coaxially with said powder tube axis.

4. The spray gun of claim 1 wherein said powder tube is generally cylindrical, and said power supply includes a central passageway that slideably receives said powder tube therethrough.

5. The spray gun of claim 4 wherein said power supply has a generally cylindrical outer surface that forms part of an outer housing of the spray gun.

6. The spray gun of claim 4 wherein said power supply comprises a high voltage multiplier.

7. The spray gun of claim 1 wherein said power supply has a generally cylindrical outer surface that forms part of an outer housing of the spray gun.

8. The spray gun of claim 7 wherein said power supply comprises a central passageway through which said powder tube extends.

9. The spray gun of claim 1 comprising a nozzle in communication with said powder tube, said nozzle having an electrode connected to an output of said power supply to charge powder flowing through said nozzle.

10. The spray gun of claim 1 comprising a nozzle in communication with said powder tube, and an electrode connected to an output of said power supply for charging powder.

11. The spray gun of claim 10 wherein said electrode is positioned to charge powder as powder flows through said powder tube.

12. A high voltage power supply for an electrostatic powder spray gun, the power supply comprising:
a generally cylindrical body having a central passageway adapted to slideably receive a powder tube when assembled into a spray gun.

13. The power supply of claim 12 wherein said power supply body comprises an insulated outer surface that forms parts of a spray gun housing when assembled into a spray gun.

14. The power supply of claim 12 wherein said power supply comprises a voltage multiplier that outputs at least 60 kV of power.

15. An electrostatic powder spray gun comprising:
a powder tube having a powder inlet end and a powder outlet end;
a nozzle in communication with said powder tube outlet end; and
a power supply that surrounds a portion of said powder tube.

16. The gun of claim 15 wherein said powder tube extends along a single straight axis from said inlet end to said outlet end.

17. The gun of claim 16 wherein said power supply is coaxial with said powder tube.

18. The gun of claim 15 wherein said power supply is generally cylindrical with a central passageway that slideably receives said powder tube.

19. The gun of claim 18 wherein said power supply comprises an outer surface that forms part of a housing of the spray gun.

20. The gun of claim 15 wherein said power supply comprises a voltage multiplier that produces at least 60 kV of power.

21. In a powder spray gun having a powder tube with an end connection for joining with a powder feed hose, the improvement comprising:
a hose clamp having a threaded portion and a plurality of flexible members extending generally axially from said threaded portion; said clamp being adapted to be installed on the powder tube end connection; and
a threaded clamping nut that is threadably installed on said hose clamp, said clamping nut having a body portion that compresses said flexible members against the hose when said nut is installed on said clamp.
